(19) United States
(12) Patent Application Publication
(10) Pub. No.: US 2019/0294242 A1
(43) Pub. Date: Sep. 26, 2019

(54) Systems, Devices, and/or Methods for Clothing

(71) Applicant: Logan Amstutz, Hart, MI (US)

(72) Inventor: Logan Amstutz, Hart, MI (US)

(21) Appl. No.: 16/237,717

(22) Filed: Jan. 1, 2019

Related U.S. Application Data
(60) Provisional application No. 62/646,385, filed on Mar. 22, 2018.

(51) Int. Cl. G06F 3/01; G06F 3/038; A41B 1/08; A41D 1/06; A41D 19/00; A41D 31/04

(52) U.S. Cl. CPC G06F 3/014; G06F 3/038; A41B 1/08; G06F 2203/0384; A41D 19/0024; A41D 31/04; G06F 2203/0331; A41D 1/06

(57) ABSTRACT

Certain exemplary embodiments can provide a system, which comprises a wireless transmitter. The system comprises a touch sensitive surface comprised by a garment. The wireless transmitter is communicatively coupled to the touch sensitive surface. The system comprises an attachment coupled to a hand of a user. The attachment is constructed to cause a signal to be transmitted via the wireless transmitter responsive to the user touching the touch sensitive surface with the attachment in a predetermined manner.

### CROSS-REFERENCES TO RELATED APPLICATIONS

This application claims priority to, and incorporates by reference herein in its entirety, pending U.S. Provisional Patent Application Ser. No. 62/646,385 (Attorney Docket No. 1256-04), filed Mar. 22, 2018.

### BRIEF DESCRIPTION OF THE DRAWINGS

A wide variety of potential embodiments will be more readily understood through the following detailed description of certain exemplary embodiments, with reference to the accompanying exemplary drawings in which:

FIG. 1 is a sketch of a view of an exemplary embodiment of a shirt 1000;

FIG. 2 is a sketch of a view of an exemplary embodiment of a pair of pants 2000;

FIG. 3 is a block diagram of an exemplary embodiment of a system 3000;

FIG. 4 is a block diagram of an exemplary embodiment of an information device 4000;

FIG. 5 is a sketch of a view of an exemplary embodiment of a finger attachment 5000;

FIG. 6 is a sketch of a view of an exemplary embodiment of a stylus 6000;

FIG. 7 is a sketch of a view of an exemplary embodiment of a system 7000;

FIG. 8 is a sketch of a view of an exemplary embodiment of a shirt 8000;

FIG. 9 is a block diagram of an exemplary embodiment of an electronic band 9000; and

FIG. 10 is a sketch of a view of an exemplary embodiment of a pair of pants 10000.

### DETAILED DESCRIPTION

Certain exemplary embodiments can provide a system, which comprises a wireless transmitter. The system comprises a touch sensitive surface comprised by a garment. The wireless transmitter is communicatively coupled to the touch sensitive surface. The system comprises an attachment coupled to a hand of a user. The attachment is constructed to cause a signal to be transmitted via the wireless transmitter responsive to the user touching the touch sensitive surface with the attachment in a predetermined manner.

Examples of touch sensitive surfaces are disclosed in U.S. Pat. No. 5,790,106, which is incorporated by reference in its entirety. Examples of fabric type input devices are disclosed in United States Patent Publication 2010/0103112, which is incorporated by reference in its entirety. Examples of smart clothing with human-to computer textile interfaces are disclosed in United States Patent Publication 2015/0370320, which is incorporated by reference in its entirety.

Certain exemplary embodiments provide a finger attachment to write on sections of clothing, which writing is sent to an app. The clothing comprises certain portions that are readily accessible by a hand of a user for writing and are constructed to transmit signals indicative of user writing. For example, a small chest area can be recordable and constructed to transmit a signal responsive to writing of the user. Certain exemplary embodiments provide a side pocket/hip/side portion constructed to transmit a signal responsive to writing of the user. In such embodiments, the user can sit down and write on their thigh. Certain exemplary embodiments provide a chest portion constructed to transmit a signal responsive to writing of the user is so the user can lie on their back and write freely. Certain exemplary embodiments provide a glove for a hand of the user. For example, a section in the middle on the back of the hand and/or in the palm of the hand possible, whichever is more comfortable so the can lay on their stomach and record thoughts. A basic concept is to allow the user to record information, such as to create a journal, etc.

In certain exemplary embodiments, the portions of clothing that are constructed to transmit a signal responsive to writing of the user can be covered to avoid nuisance signals. The user can uncover the portions of the clothing such that the user can write on the portions such that the signal is transmitted.

Certain exemplary embodiments provide clothing that has areas that cover replaceable paper sheets. The user can uncover the paper sheets (e.g., small squares of paper) and write on them. The user can remove any of the paper sheets and/or replace the paper sheets. For example, the user can write on a piece of paper, remove the piece of paper from the clothing, place the piece of paper in a pocket, and/or destroy the piece of paper after a predetermined time period. The areas that are constructed to cover sheets of paper can vary as to size and/or shape. In certain exemplary embodiments, covers over paper sheets can be plastic, which are coupled to clothing via hook and loop fasteners.

The clothing can be any article such as, for example, a t-shirt, a long sleeved shirt, a hoodie, shorts, or pants.

In certain exemplary embodiments, the user can be prompted what to write, such as via an electronic band (e.g., a wrist band) worn by the user. In certain exemplary embodiments, the electronic band can be of a size that can be placed in a pocket of an article of clothing of the user. In certain exemplary embodiments, the band can vibrate to signal a user to take some action.

In certain exemplary embodiments, the writing of the user can be related to financial management and/or budgeting. For example the electronic band can prompt the user to pick a service provider (e.g., a college) and can prompt the user to budget for a service of the service provider and/or select a location of the service provider. Timing of the prompts can vary in order to accomplish a particular psychological goal.

In certain exemplary embodiments, the writing of the user can be related to locations. In certain exemplary embodiments, the writing of the user can be related to people. In certain exemplary embodiments, the writing of the user can be related to educational institutions. In certain exemplary embodiments, the writing of the user can be related to financial management and/or budgeting.

For example, the electronic band can instruct the user to pull a piece of paper from an article of clothing and write on the piece of paper. The electronic band can then instruct the user to replace the piece of paper to under a cover of a portion of the clothing that can hold the piece of paper. The electronic band can instruct the user to destroy the piece of paper at a predetermined time.

Certain exemplary embodiments provide clothing line that comprises portions with electronic signaling capability. The portions with electronic signaling capability are constructed to transmit messages written on the clothing by the user. In certain exemplary embodiments, the messages are transmitted to the Internet capability, such as to a social media website. In certain exemplary embodiments, the messages can also be transmitted to a predetermined person at a messaging service. Certain exemplary embodiments allow the user to text using one or more portions on the clothing.

Certain exemplary embodiments have application in psychological applications. Information received from a user can be cataloged and used for therapeutic purposes.

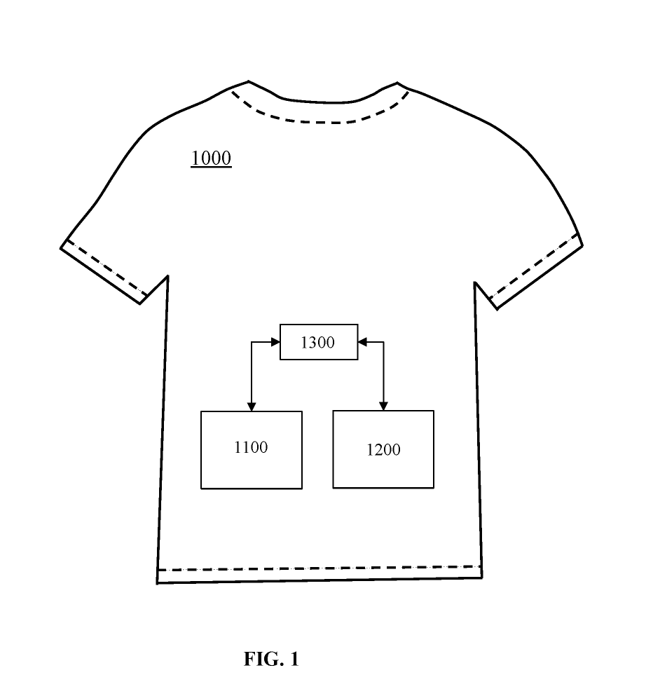

FIG. 1 is a sketch of a view of an exemplary embodiment of a shirt 1000. Shirt 1000 comprises a first touch sensitive surface 1100 and a second touch sensitive surface 1200. The locations and/or relative sizes of first touch sensitive surface 1100 and second touch sensitive surface 1200 on shirt 1000 are exemplary and not limiting. For example, a single or more than two touch sensitive surfaces can be used. Different sized touch sensitive surfaces can be used. One or more touch sensitive surfaces can be installed at any location of shirt 1000 that are accessible by one or more fingers of a wearing user. In certain exemplary embodiments, first touch sensitive surface 1100 and/or second touch sensitive surface 1200 can be releasably coupled to shirt 1000 via, for example, a set of hook and loop fasteners and/or an adhesive.

Certain exemplary embodiments provide a wireless transceiver 1300, which comprises a wireless transmitter. Wireless transceiver 1300 is communicatively coupled to first touch sensitive surface 1100 and/or second touch sensitive surface 1200, which are comprised by a garment (e.g., shirt 1000). Wireless transceiver 1300, and hence the wireless transmitter is coupled to first touch sensitive surface 1100 and/or second touch sensitive surface 1200.

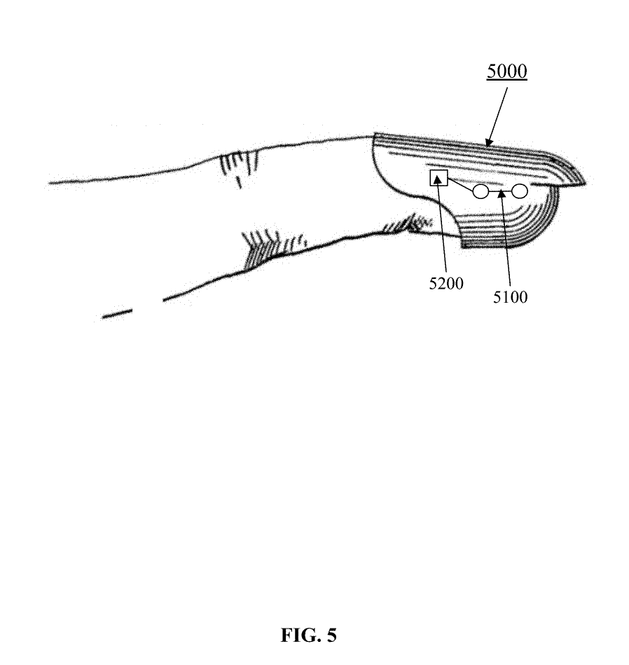

An attachment (e.g., finger attachment 5000 of FIG. 5) can be coupled to a hand of a user. The attachment is constructed to cause a signal to be transmitted via the wireless transmitter of wireless transceiver 1300 responsive to the user touching the touch sensitive surface with the attachment in a predetermined manner.

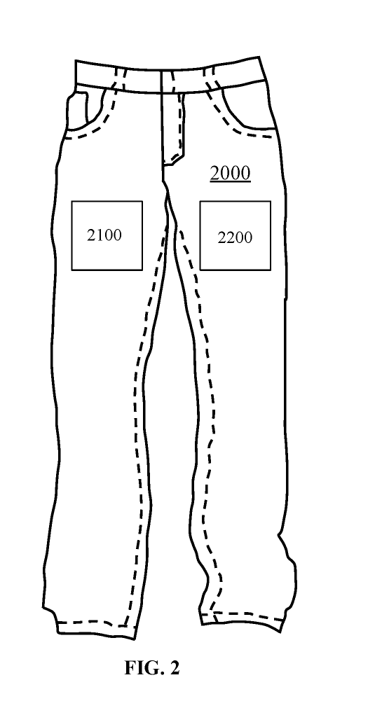

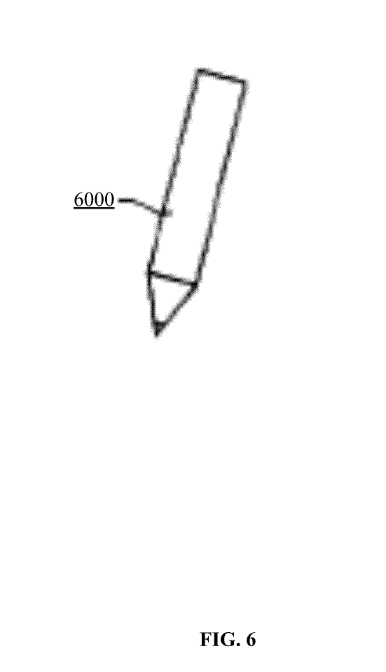

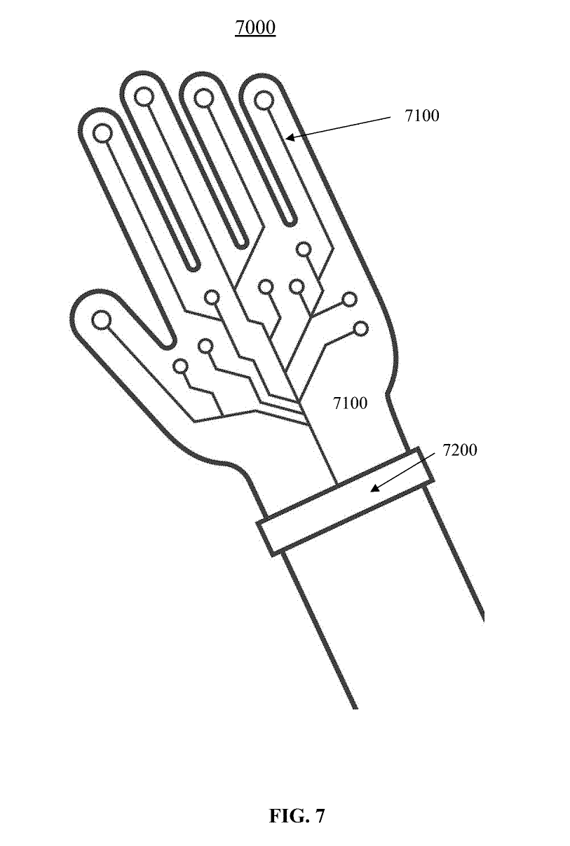

The garment can be a shirt, such as illustrated in FIG. 1. The garment can be pants, such as illustrated in FIG. 2. The attachment can be a stylus, such as illustrated in FIG. 6. The attachment can be coupled to a finger of the user, such as illustrated in FIG. 5. The attachment is comprised by a glove, such as illustrated in FIG. 7.

The signal can be transmitted to a social media website. The signal can be transmitted to a medical provider

FIG. 2 is a sketch of a view of an exemplary embodiment of a pair of pants 2000, which can comprise a first touch sensitive surface 2100 and a second touch sensitive surface 2200. The locations and/or relative sizes of first touch sensitive surface 2100 and second touch sensitive surface 2200 on pair of pants 2000 are exemplary and not limiting. For example, a single or more than two touch sensitive surfaces can be used. Different sized touch sensitive surfaces can be used. One or more touch sensitive surfaces can be installed at any location of pair of pants 2000 that are accessible by one or more fingers of a wearing user. In certain exemplary embodiments, first touch sensitive surface 2100 and/or second touch sensitive surface 2200 can be releasably coupled to pair of pants 2000 via, for example, a set of hook and loop fasteners and/or an adhesive.

Each of first touch sensitive surface 1100 and second touch sensitive surface 1200 of FIG. 1 and first touch sensitive surface 2100 and second touch sensitive surface 2200 of FIG. 2 can be based upon one or more surfaces disclosed in publications such as U.S. Pat. No. 8,314,775, which is incorporated by reference herein in its entirety.

Each of first touch sensitive surface 1100 and second touch sensitive surface 1200 of FIG. 1 and first touch sensitive surface 2100 and second touch sensitive surface 2200 of FIG. 2 are constructed to provide a wireless signal to an information device responsive to a human touch. For example, a wearing user can write characters on any touch sensitive surface, which can be parsed to words and/or phrases. Certain exemplary embodiments can utilize algorithms to recognize characters based upon the wearing user's handwriting and algorithms that use heuristic rules to parse the handwritten characters into words and phrases. For example, one or more methods such as is disclosed in U.S. Pat. No. 7,724,957, which is incorporated by reference herein in its entirety, can be used.

Responsive to a determination that the wearing user has completed a message, certain exemplary embodiments can automatically post the message to a predetermined location such as a memory device, an Internet blog, a social media website, and/or an online diary, etc. Via such automatic posting, the wearing user can easily, frequently, and/or conveniently place personal updates on a social media website.

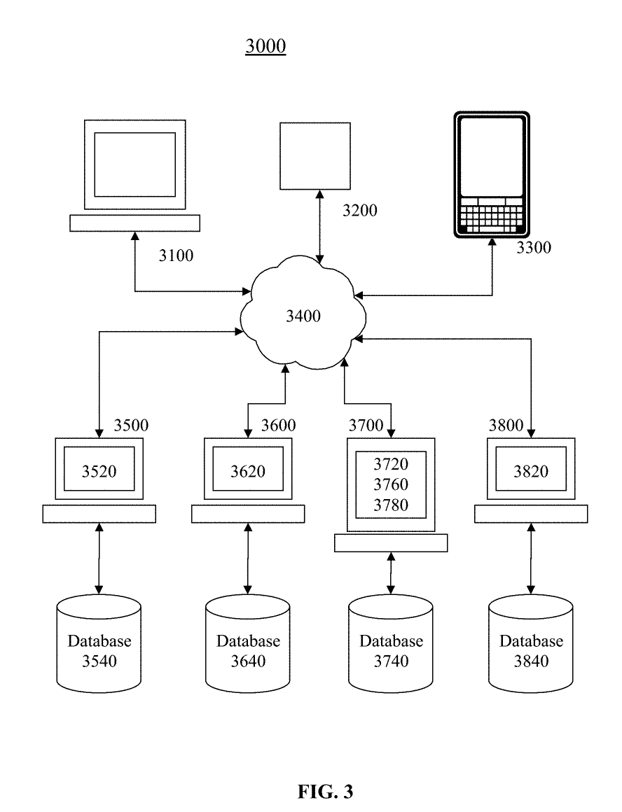

FIG. 3 is a block diagram of an exemplary embodiment of a system 3000, which can comprise a smartphone 3300, an information device 3100, tablet 3200, a network 3400, a first server 3500, a second server 3600, a third server 3700, and a fourth server 3800. First server 3500 can comprise a first user interface 3520 and can be coupled to a first database 3540. Second server 3600 can comprise a second user interface 3620 and can be coupled to a second database 3640. Third server 3700 can comprise a third user interface 3720, a processor 3760, machine instructions 3780, and can be coupled to a third database 3740. Fourth server 3800 can comprise a fourth user interface 3820 and can be coupled to a fourth database 3840. Any of the methods and/or steps thereof can be carried out in whole or in part by tablet 3200, smartphone 3300, information device 3100 and/or first server 3500. Second server 3600, third server 3700, and/or fourth server 3800 can each be associated with implementation of a system via which facilitates communication of a user utilizing a finger pointer that is communicatively coupled to a band that can be worn around a wrist of a user. In certain exemplary embodiments, system 3000 can be used to implement one or more methods disclosed herein.

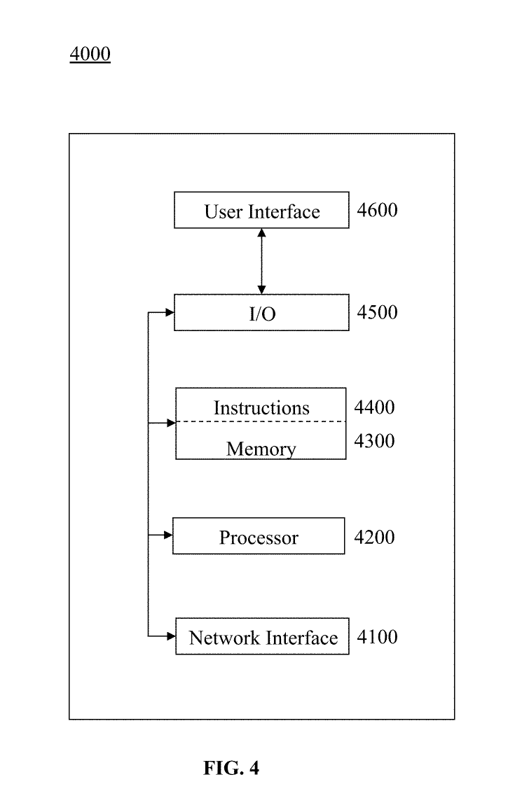

FIG. 4 is a block diagram of an exemplary embodiment of an information device 4000, which in certain operative embodiments can comprise, for example, first server 3500, and/or user information device 3100, of FIG. 3. Information device 4000 can comprise any of numerous circuits and/or components, such as for example, one or more network interfaces 4100, one or more processors 4200, one or more memories 4300 containing instructions 4400, one or more input/output (I/O) devices 4500, and/or one or more user interfaces 4600 coupled to one or more input/output (I/O) devices 4500, etc.

In certain exemplary embodiments, via one or more user interfaces 4600, such as a graphical user interface, a user can view a rendering of information related to a user communicating with an information device.

FIG. 5 is a sketch of a view of an exemplary embodiment of a finger attachment 5000. Finger attachment 5000 can be constructed to interact with a touch sensitive surface (such as first touch sensitive surface 1100 and/or second touch sensitive surface 1200 of FIG. 1). In certain exemplary embodiments, finger attachment 5000 comprises an electronic sensor system 5100, which detects finger movement. Signals indicative of finger movement can be transmitted via a wireless transmitter 5200 to an information device for processing.

FIG. 6 is a sketch of a view of an exemplary embodiment of a stylus 6000. Stylus 6000 is constructed to interact with a touch sensitive surface (such as first touch sensitive surface 1100 and/or second touch sensitive surface 1200 of FIG. 1).

FIG. 7 is a sketch of a view of an exemplary embodiment of a system 7000, which comprises a glove 7100. Glove 7100 is constructed to interact with a surface (such as first touch sensitive surface 1100 and/or second touch sensitive surface 1200 of FIG. 1). In certain exemplary embodiments, glove 7100 comprises an electronic sensor system 7200, which detects finger and/or hand movement. Signals indicative of finger movement can be transmitted via a wireless transmitter 7300 to an information device for processing.

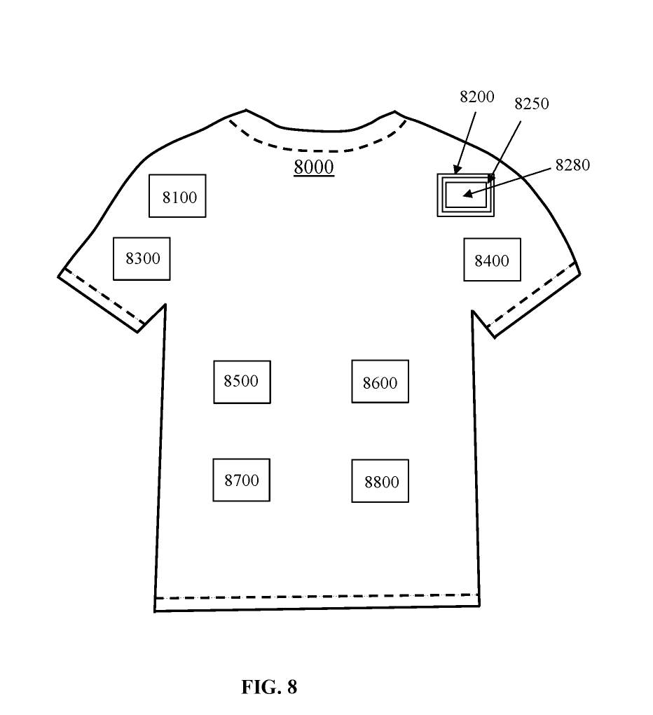

FIG. 8 is a sketch of a view of an exemplary embodiment of a shirt 8000. Shirt 8000 comprises one or more compartments, such as first compartment 8100, second compartment 8200, third compartment 8300, fourth compartment 8400, fifth compartment 8500, sixth compartment 8600, seventh compartment 8700, and/or eighth compartment 8800. In certain exemplary embodiments, shirt 8000 can be:
a hoodie; or
a short sleeved shirt; or
a long sleeved shirt.

Shirt 8000 can be constructed for use in a rewrite retain remember program. One or more of first compartment 8100, second compartment 8200, third compartment 8300, fourth compartment 8400, fifth compartment 8500, sixth compartment 8600, seventh compartment 8700, and/or eighth compartment 8800 can be constructed to hold writing surfaces. The writing surfaces can be papers, which can be coupled to the shirt via an adhesive strip. In certain exemplary embodiments, one or more of first compartment 8100, second compartment 8200, third compartment 8300, fourth compartment 8400, fifth compartment 8500, sixth compartment 8600, seventh compartment 8700, and/or eighth compartment 8800 can be covered by a substantially transparent cover (see, e.g., substantially transparent cover 8250). Substantially transparent cover 8250 can be opened, such as via hook and loop fasteners, such that the user can write on writing surfaces (e.g., papers). Substantially transparent cover 8250 is illustrative in nature and each of first compartment 8100, second compartment 8200, third compartment 8300, fourth compartment 8400, fifth compartment 8500, sixth compartment 8600, seventh compartment 8700, and/or eighth compartment 8800 can be covered by substantially transparent covers.

In certain exemplary embodiments, a garment (e.g., shirt 8000) comprises one or more of first compartment 8100, second compartment 8200, third compartment 8300, fourth compartment 8400, fifth compartment 8500, sixth compartment 8600, seventh compartment 8700, and/or eighth compartment 8800. First compartment 8100, second compartment 8200, third compartment 8300, fourth compartment 8400, fifth compartment 8500, sixth compartment 8600, seventh compartment 8700, and/or eighth compartment 8800 can be covered by transparent cover 8250. Transparent cover 8250 can be constructed to be opened and closed by a user. Shirt 8000 comprises a surface 8280, which is constructed to record writing. Surface 8280 is illustrated in a typical manner and each of first compartment 8100, second compartment 8200, third compartment 8300, fourth compartment 8400, fifth compartment 8500, sixth compartment 8600, seventh compartment 8700, and/or eighth compartment 8800 can hold a similar or substantially identical surface. Surface 8280 is removeably storable in one of first compartment 8100, second compartment 8200, third compartment 8300, fourth compartment 8400, fifth compartment 8500, sixth compartment 8600, seventh compartment 8700, and/or eighth compartment 8800.

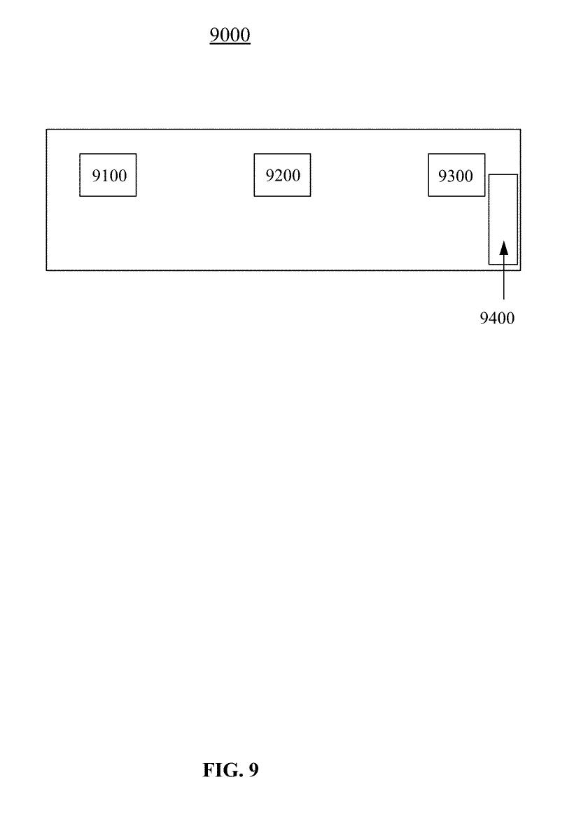

FIG. 9 is a block diagram of an exemplary embodiment of an electronic band 9000. Electronic band 9000 comprises a first button 9100, a second button 9200, and/or a third button 9300. One of first button 9100, a second button 9200, and/or a third button 9300 can be constructed to:
describe writing and rewriting to be performed by the user;
direct the user what to write;
cause an audible sound to emanate from a speaker 9400 (e.g., a designated location of a piece of paper to write on and/or a subject to write about, etc.);
cause a signal to be transmitted to an information device (e.g., to an Internet social media website, etc.); and/or
a timer that prompts and/or instructs the user when to perform an action.

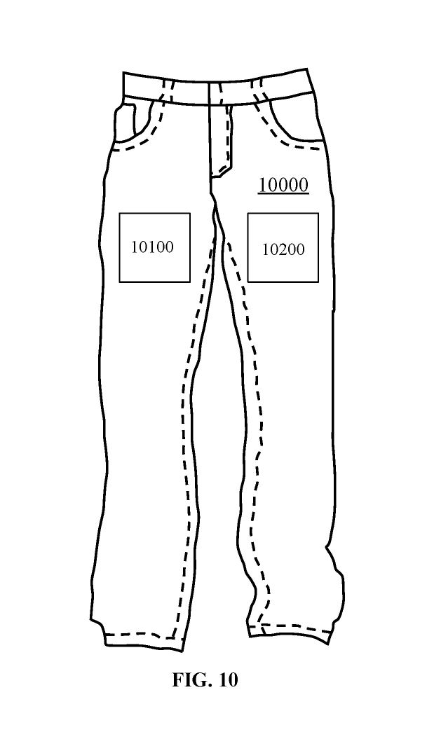

FIG. 10 is a sketch of a view of an exemplary embodiment of a pair of pants 10000. Pants 10000 can comprise one or more compartments, such as first compartment 10100 and/or second compartment 10200.

Certain exemplary embodiments provide a method, which can comprise causing a signal to be transmitted from a wireless transmitter. The wireless transmitter is coupled to a touch sensitive surface comprised by a garment. The signal can be caused by an attachment coupled to a hand of a user interacting with the touch sensitive surface. The garment can be a shirt and the touch sensitive surface can be located on a chest area or any other area of the shirt. The garment can be pants and the touch sensitive surface is located on a hip area or any other area of the of the pants. The attachment can be comprised by a glove. The signal can be transmitted to a social media website and/or to a medical provider

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, step, and/or process or portion thereof
adapter—a device used to effect operative compatibility between different parts of one or more pieces of an apparatus or system.
and/or—either in conjunction with or in alternative to.
apparatus—an appliance or device for a particular purpose
associate—to join, connect together, and/or relate.
attachment—a coupled device.
automatically—acting or operating in a manner essentially independent of external influence or control. For example, an automatic light switch can turn on upon “seeing” a person in its view, without the person manually operating the light switch.
can—is capable of, in at least some embodiments.
circuit—an electrically conductive pathway and/or a communications connection established across two or more switching devices comprised by a network and between corresponding end systems connected to, but not comprised by the network.
close—covering a compartment.
compartment—a partitioned space.
comprising—including but not limited to.
configure—to make suitable or fit for a specific use or situation.
connect—to join or fasten together.
constructed to—made to and/or designed to.
convert—to transform, adapt, and/or change.
couple—to link in some fashion.
coupleable—capable of being joined, connected, and/or linked together.
cover—a thing that lies on or over an compartment in order to control ingress and/or egress of objects via the compartment.
data—distinct pieces of information, usually formatted in a special or predetermined way and/or organized to express concepts.
define—to establish the outline, form, or structure of
determine—to obtain, calculate, decide, deduce, and/or ascertain.
device—a machine, manufacture, and/or collection thereof.
garment—an article of clothing.
generate—to create, produce, give rise to, and/or bring into existence.
glove—a shaped hand covering.
haptic—involving the human sense of kinesthetic movement and/or the human sense of touch. Among the many potential haptic experiences are numerous sensations, body-positional differences in sensations, and time-based changes in sensations that are perceived at least partially in non-visual, non-audible, and non-olfactory manners, including the experiences of tactile touch (being touched), active touch, grasping, pressure, friction, traction, slip, stretch, force, torque, impact, puncture, vibration, motion, acceleration, jerk, pulse, orientation, limb position, gravity, texture, gap, recess, viscosity, pain, itch, moisture, temperature, thermal conductivity, and thermal capacity.
information device—any device capable of processing data and/or information, such as any general purpose and/or special purpose computer, such as a personal computer, workstation, server, minicomputer, mainframe, supercomputer, computer terminal, laptop, wearable computer, and/or Personal Digital Assistant (PDA), mobile terminal, Bluetooth device, communicator, “smart” phone (such as a Treo-like device), messaging service (e.g., Blackberry) receiver, pager, facsimile, cellular telephone, a traditional telephone, telephonic device, a programmed microprocessor or microcontroller and/or peripheral integrated circuit elements, an ASIC or other integrated circuit, a hardware electronic logic circuit such as a discrete element circuit, and/or a programmable logic device such as a PLD, PLA, FPGA, or PAL, or the like, etc. In general any device on which resides a finite state machine capable of implementing at least a portion of a method, structure, and/or or graphical user interface described herein may be used as an information device. An information device can comprise components such as one or more network interfaces, one or more processors, one or more memories containing instructions, and/or one or more input/output (I/O) devices, one or more user interfaces coupled to an I/O device, etc.
input/output (I/O) device—any sensory-oriented input and/or output device, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.
install—to connect or set in position and prepare for use.
machine instructions—directions adapted to cause a machine, such as an information device, to perform one or more particular activities, operations, or functions. The directions, which can sometimes form an entity called a “processor”, “kernel”, “operating system”, “program”, “application”, “utility”, “subroutine”, “script”, “macro”, “file”, “project”, “module”, “library”, “class”, and/or “object”, etc., can be embodied as machine code, source code, object code, compiled code, assembled code, interpretable code, and/or executable code, etc., in hardware, firmware, and/or software.
machine readable medium—a physical structure from which a machine can obtain data and/or information. Examples include a memory, punch cards, etc.
manner—a way of doing.
may—is allowed and/or permitted to, in at least some embodiments.
medical provider—an individual or institution that treats patient maladies.
memory device—an apparatus capable of storing analog or digital information, such as instructions and/or data. Examples include a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. The memory device can be coupled to a processor and/or can store instructions adapted to be executed by processor, such as according to an embodiment disclosed herein.
method—a process, procedure, and/or collection of related activities for accomplishing something.
network—a communicatively coupled plurality of nodes. A network can be and/or utilize any of a wide variety of sub-networks, such as a circuit switched, public-switched, packet switched, data, telephone, telecommunications, video distribution, cable, terrestrial, broadcast, satellite, broadband, corporate, global, national, regional, wide area, backbone, packet-switched TCP/IP, Fast Ethernet, Token Ring, public Internet, private, ATM, multi-domain, and/or multi-zone sub-network, one or more Internet service providers, and/or one or more information devices, such as a switch, router, and/or gateway not directly connected to a local area network, etc.
network interface—any device, system, or subsystem capable of coupling an information device to a network. For example, a network interface can be a telephone, cellular phone, cellular modem, telephone data modem, fax modem, wireless transceiver, Ethernet card, cable modem, digital subscriber line interface, bridge, hub, router, or other similar device.
open—allowing access to inside.
packet—a discrete instance of communication.
pants—an article of clothing worn on a lower part of a body of a user, the lower part of the body comprising legs of the user.
plurality—the state of being plural and/or more than one.
predetermined—established in advance.
processor—a device and/or set of machine-readable instructions for performing one or more predetermined tasks. A processor can comprise any one or a combination of hardware, firmware, and/or software. A processor can utilize mechanical, pneumatic, hydraulic, electrical, magnetic, optical, informational, chemical, and/or biological principles, signals, and/or inputs to perform the task(s). In certain embodiments, a processor can act upon information by manipulating, analyzing, modifying, converting, transmitting the information for use by an executable procedure and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium IV series of microprocessor manufactured by the Intel Corporation of Santa Clara, Calif. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein.
project—to calculate, estimate, or predict.
provide—to furnish, supply, give, and/or make available.
receive—to get as a signal, take, acquire, and/or obtain.
recommend—to suggest, praise, commend, and/or endorse.
record—to set down in some tangible form (e.g., write on a paper) for later reference.
remove—to take something out of a space (e.g., to take something out of a compartment).
render—to make perceptible to a human, for example as data, commands, text, graphics, audio, video, animation, and/or hyperlinks, etc., such as via any visual, audio, and/or haptic means, such as via a display, monitor, electric paper, ocular implant, cochlear implant, speaker, etc.
repeatedly—again and again; repetitively.
request—to express a desire for and/or ask for.
responsive—reacting to an influence and/or impetus.
sense—to detect or perceive automatically.
sensitive—able to sense.
set—a related plurality.
shirt—an article of clothing worn on an upper body of a user.
signal—information, such as machine instructions for activities and/or one or more letters, words, characters, symbols, signal flags, visual displays, and/or special sounds, etc. having prearranged meaning, encoded as automatically detectable variations in a physical variable, such as a pneumatic, hydraulic, acoustic, fluidic, mechanical, electrical, magnetic, optical, chemical, and/or biological variable, such as power, energy, pressure, flowrate, viscosity, density, torque, impact, force, frequency, phase, voltage, current, resistance, magnetomotive force, magnetic field intensity, magnetic field flux, magnetic flux density, reluctance, permeability, index of refraction, optical wavelength, polarization, reflectance, transmittance, phase shift, concentration, and/or temperature, etc. Depending on the context, a signal and/or the information encoded therein can be synchronous, asynchronous, hard real-time, soft real-time, non-real time, continuously generated, continuously varying, analog, discretely generated, discretely varying, quantized, digital, broadcast, multicast, unicast, transmitted, conveyed, received, continuously measured, discretely measured, processed, encoded, encrypted, multiplexed, modulated, spread, de-spread, demodulated, detected, de-multiplexed, decrypted, and/or decoded, etc.
social media website—a
store—to place, hold, and/or retain data, typically in a memory.
stylus—a device constructed to input commands, handwritten text, and/or drawings, etc.
substantially—to a great extent or degree.
support—to bear the weight of, especially from below.
surface—the outer boundary of an object or a material layer.
system—a collection of mechanisms, devices, machines, articles of manufacture, processes, data, and/or instructions, the collection designed to perform one or more specific functions.
touch—to contact something.
transmit—to send as a signal, provide, furnish, and/or supply.
transparent—allowing light to pass through so that objects behind can be distinctly seen with a human eye.
user interface—any device for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.
via—by way of and/or utilizing.
wireless transceiver—a device constructed to transfer signals between sources and destinations without the use of wires.
wireless transmitter—a device constructed to transfer a signal from a source to a destination without the use of wires.
writing—a medium of human communication in which information is conveyed via recorded signs and symbols.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A system comprising:
a wireless transmitter;
a touch sensitive surface comprised by a garment, the wireless transmitter coupled to the touch sensitive surface;
an attachment coupled to a hand of a user, the attachment constructed to cause a signal to be transmitted via the wireless transmitter responsive to the user touching the touch sensitive surface with the attachment in a predetermined manner.

2. The system of claim 1, wherein:
the garment is a shirt.

3. The system of claim 1, wherein:
the garment is pants.

4. The system of claim 1, wherein:
the attachment is a stylus.

5. The system of claim 1, wherein:
the attachment is coupled to a finger of the user.

6. The system of claim 1, wherein:
the attachment is comprised by a glove.

7. The system of claim 1, wherein:
the signal is transmitted to a social media website.

8. The system of claim 1, wherein:
the signal is transmitted to a medical provider.

9. A method comprising:
causing a signal to be transmitted from a wireless transmitter, the wireless transmitter coupled to a touch sensitive surface comprised by a garment, wherein the signal is caused by an attachment coupled to a hand of a user interacting with the touch sensitive surface.

10. The method of claim 9, wherein:
the garment is a shirt and the touch sensitive surface is located on a chest area of the shirt.

11. The method of claim 9, wherein:
the garment is pants and the touch sensitive surface is located on a hip area of the pants.

12. The method of claim 9, wherein:
the attachment is comprised by a glove.

13. The method of claim 9, wherein:
the signal is transmitted to a social media website.

14. The method of claim 9, wherein:
the signal is transmitted to a medical provider.

15. A system comprising:
a garment, the garment comprising a compartment, the compartment covered by an transparent cover, the transparent cover constructed to be opened and closed by a user; and
a surface constructed to record writing, the surface removeably storable in the compartment.
